(19) United States
(12) Patent Application Publication
(10) Pub. No.: US 2009/0254439 A1
(43) Pub. Date: Oct. 8, 2009

(54) Touch Screen Device With Fuel Pump Access

(75) Inventor: William DUNN, Alpharetta, GA (US)

Correspondence Address: STANDLEY LAW GROUP LLP, 6300 Riverside Drive, Dublin, OH, 43017, US

(73) Assignee: MANUFACTURING RESOURCES INTERNATIONAL, INC., Alpharetta, GA (US)

(21) Appl. No.: 12/360,084

(22) Filed: Jan. 26, 2009

Related U.S. Application Data
(63) Continuation-in-part of application No. 12/266,233, filed on Nov. 6, 2008.
Application No. 12/266,233 is a continuation-in-part of application No. 29/322,897, filed on Aug. 14, 2008, now Pat. No. D595678.
(60) Provisional application No. 61/041,769, filed on Apr. 2, 2008.

(51) Int. Cl. G06Q 30/00; G06Q 20/00; G06Q 50/00; G06F 3/041

(52) U.S. Cl. 705/17; 705/27; 705/24; 345/173

(57) ABSTRACT

Embodiments provide a touch screen display in proximity to a fuel pump. The touch screen display presents a graphical user interface (GUI) containing a plurality of in-store products available for purchase. Exemplary embodiments may contain a card reading device whereby in-store items selected for purchase may be purchased at the fuel pump. A second display may be placed within the convenience store or restaurant so that purchased items may be prepared for pickup by the user. Other embodiments may provide an ordering system in proximity to the pump where the in-store goods are purchased within the store. Exemplary embodiments would be capable of producing high-definition video on the touch screen display. Some embodiments also include audio systems and proximity sensors. Wired or wireless electrical connectivity may be used to send the video and/or GUI data to the touch screen display.

### CROSS-REFERENCE TO RELATED APPLICATIONS

This application is a non-provisional patent application and claims priority to the following co-pending applications U.S. application Ser. No. 12/266,233 filed Nov. 6, 2008, which is a non-provisional application of U.S. application Ser. No. 61/041,769 filed Apr. 2, 2008 and U.S. application Ser. No. 29/322,897 Aug. 14, 2008; each of which are incorporated by reference, as if cited fully herein.

### TECHNICAL FIELD

This invention generally relates to touch screen displays and more particularly to touch screen displays mounted on fuel pumps and capable of purchasing in-store goods.

### BACKGROUND OF THE ART

Fuel pumps, similar to those found at common gas stations, typically contain a module which allows the patron to pay for the fuel at the pump without having to enter the store. This is often referred to as ‘pay at the pump.’ This has proven very successful as many patrons wish to complete their fuel purchase in as little time as possible and appreciate the convenience of purchasing the fuel at the pump without having to enter the store itself.

Convenience stores however, desire patrons to enter the store, thus increasing the chances that the patron may see a product that they would like to purchase and preferably purchasing one or more products within the store. The increased popularity in ‘pay at the pump’ has resulted in a decrease in the number of patrons who actually enter the store. It has been found that a high percentage of fuel patrons currently purchase fuel without entering the associated convenience store. It has also been found that the time spent while waiting for the purchased fuel to dispensed can be used to display advertisements about current products which are available in the convenience store. It is desirable to offer various products for purchase while the patron remains at the pump, thus resulting in beneficial sales for the convenience stores and also allowing the patron to complete their stop at the fuel-station/convenience-store in a quick and efficient manner.

### SUMMARY OF THE EXEMPLARY EMBODIMENTS

Exemplary embodiments provide a touch screen display which is positioned near the fuel pump, where the touch screen display provides information regarding the various products which are available within the convenience store or an optional attached restaurant. The available products may be offered by the convenience store, or an attached restaurant, or both. The products may be, but are not limited to, any one of the following: pre-packaged food items, demand-prepared food items, services, beverages, snacks, cigarettes, and other common convenience store items.

Exemplary embodiments allow a patron to utilize the touch screen display to find the items that they desire and select them for purchase. Items may be purchased either at the pump or within the store. Some embodiments have an additional card reading device, so that patrons may purchase in-store items at the pump. Some embodiments utilize the existing fuel pump card reader to allow users to purchase in-store items at the pump. Other embodiments permit users to order in-store items from the pump, but the items are paid for within the store.

The foregoing and other features and advantages of the exemplary embodiments will be apparent from the following more detailed description of the particular embodiments of the invention, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 is a perspective view of an embodiment where the touch screen display is placed above a fuel pump.

FIG. 2 is a front view of an embodiment where the touch screen display contains a card reader device.

FIGS. 3A-3H are screen shots for some embodiments of the touch screen menus for ordering a sandwich from the convenience store or an attached restaurant.

FIGS. 4-7 are electrical schematic views showing the electronic components which may be used with various embodiments.

### DETAILED DESCRIPTION

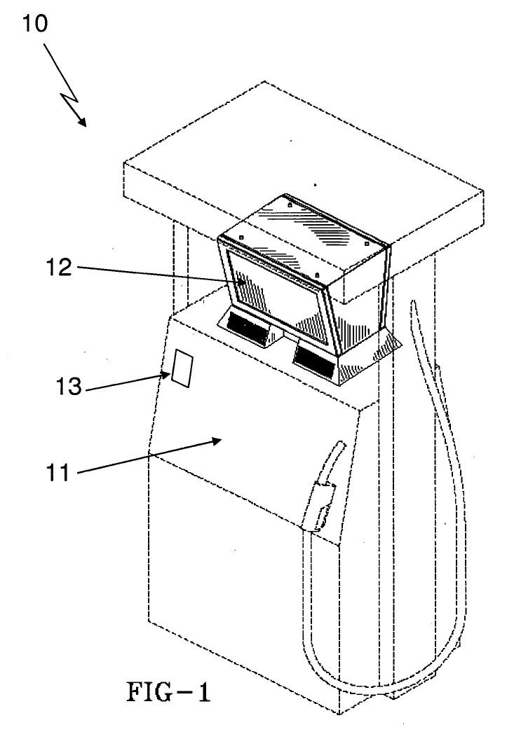

FIG. 1 shows an exemplary embodiment 10 where the touch screen display 12 is located immediately above the fuel pump 11. In this figure, the fuel pump 11 is shown with broken lines so that the dimensions of the display 12 may be more easily observed. It should be noted that it is not a requirement for any embodiment for locating the display 12 in the precise location shown in FIG. 1. Embodiments may locate the display 12 to either side of the fuel pump 11 or may integrate the touch screen display 12 with the fuel pump 11 itself. The display 12 is not required to be adjacent to the fuel pump 11 but is only required to be in proximity to the fuel pump 11. Embodiments may place the display 12 between approximately 5 and 25 feet from the fuel pump 11.

The traditional card reader 13 is shown on the fuel pump 11 and is traditionally used for ‘pay at the pump’ purchases of fuel. Some embodiments may allow patrons to select items for purchase from the display 12, and utilize the traditional card reader 13 for payment of the selected items.

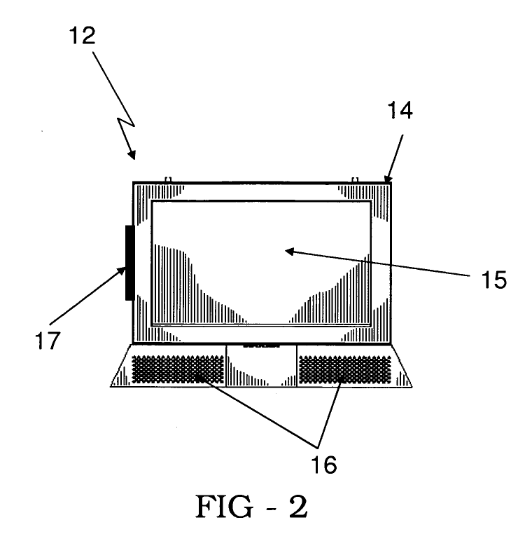

FIG. 2 shows an exemplary embodiment for the touch screen display 12. A housing 14 may be used to enclose the interior electronics for the display and protect the various components from the elements. The display area 15 may display advertisements and menu icons for selection by the patron. Screen shots for an embodiment of the display area 15 are discussed in detail below. An optional audio device 16 may be used to send audio messages, music, instructions, advertising messages, and/or sound effects to the patron. The audio device 16 may comprise a hypersonic sound device which transmits audio at a frequency above 20 k Hz. A proximity sensor (not shown) may also be used with the display 12 to sense the presence of a patron (or their automobile) and begin an advertising stream or other associated messages upon their presence.

Also shown is the optional touch screen card reader 17, which allows patrons to pay for in-store items while still at the fuel pump. This may permit the display 12 to function as a point of sale (POS) device, thus containing all the necessary hardware and software required to facilitate payment by the patron. However, as discussed above, some embodiments may use the traditional card reader 13 (shown in FIG. 1) to complete the POS device. Again, further embodiments may allow patrons to order items from the display 12, but must pay for the associated items with POS devices within the store.

It should be noted that any form of touch screen technology may be used in the exemplary embodiments. These technologies would include but are by no means limited to: 4 or 5 wire resistance, surface acoustic wave, infrared, and near field imaging. Further, embodiments may be practiced with any form of flat panel display, including but not limited to LCD, plasma, and organic LED.

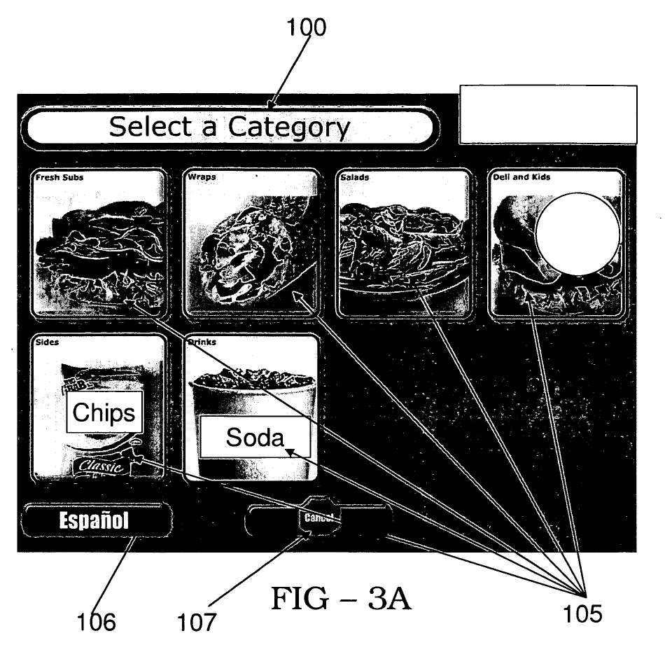

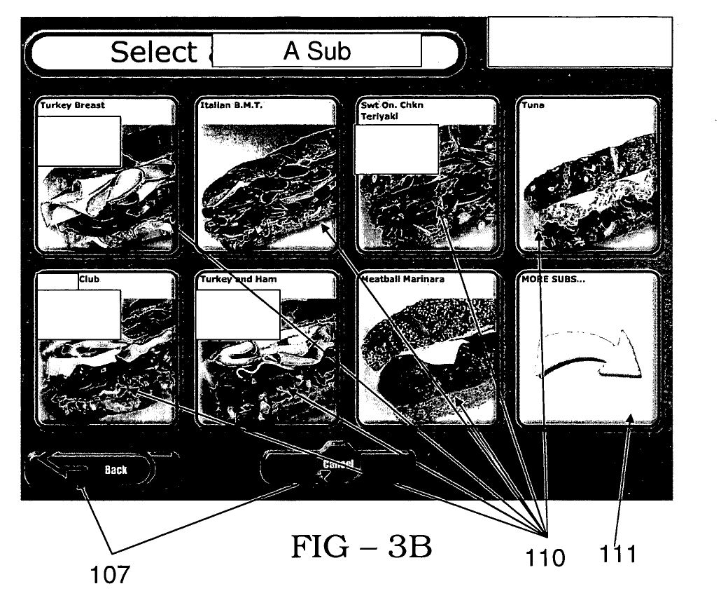

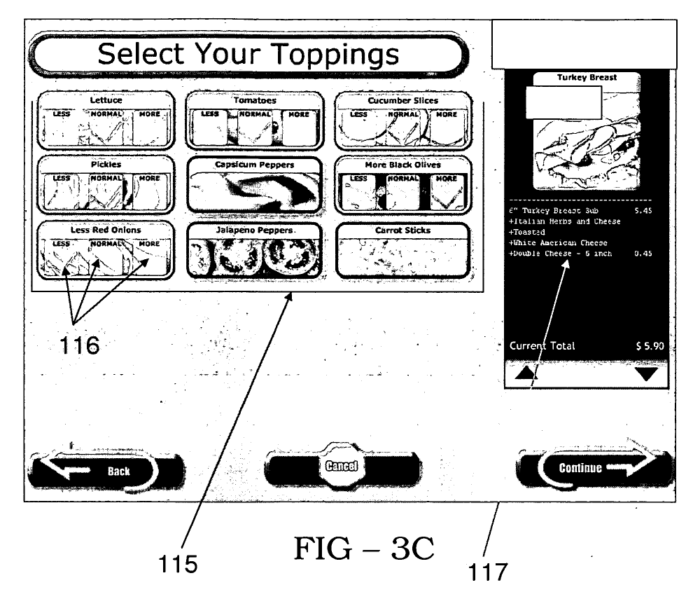

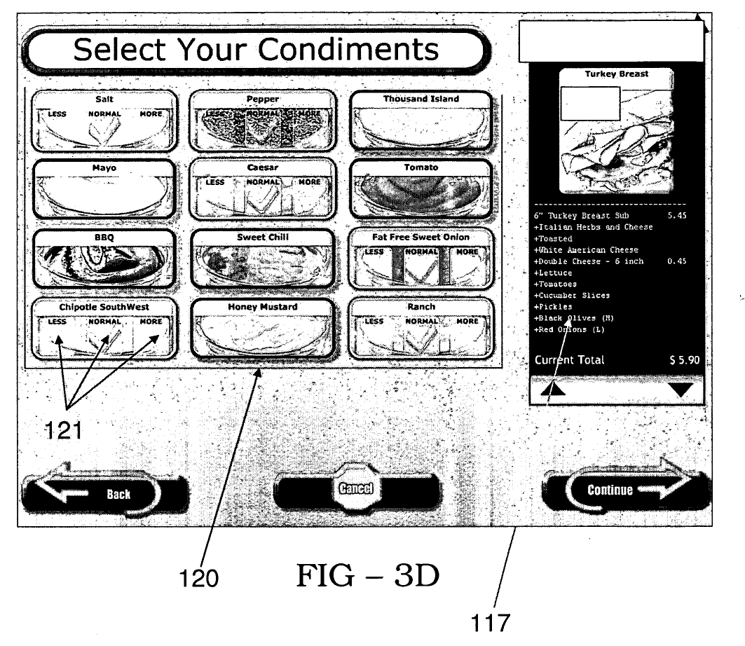

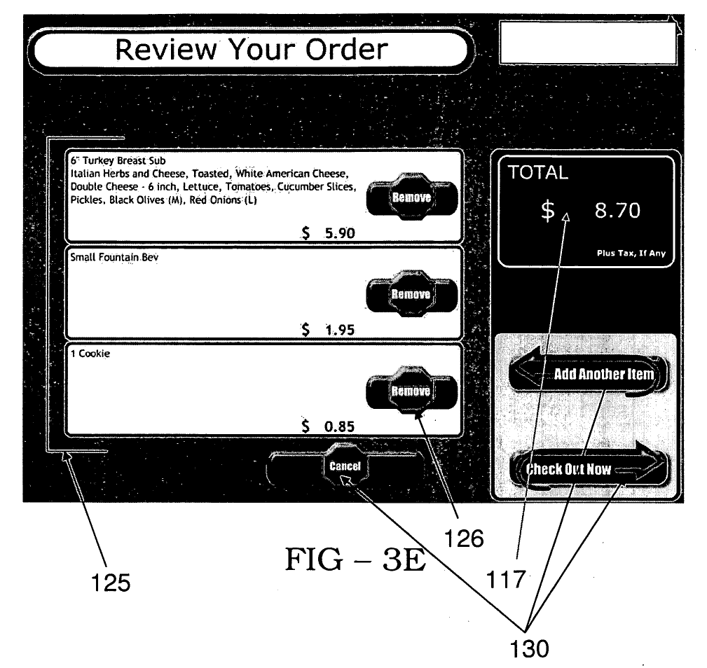

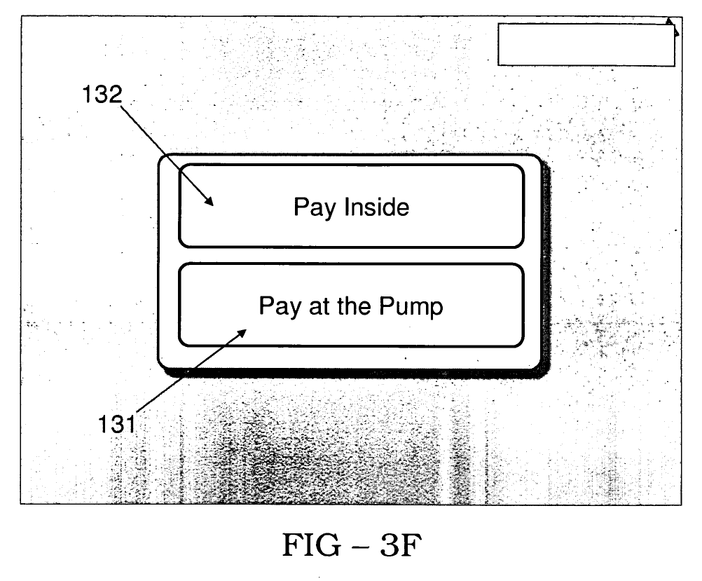

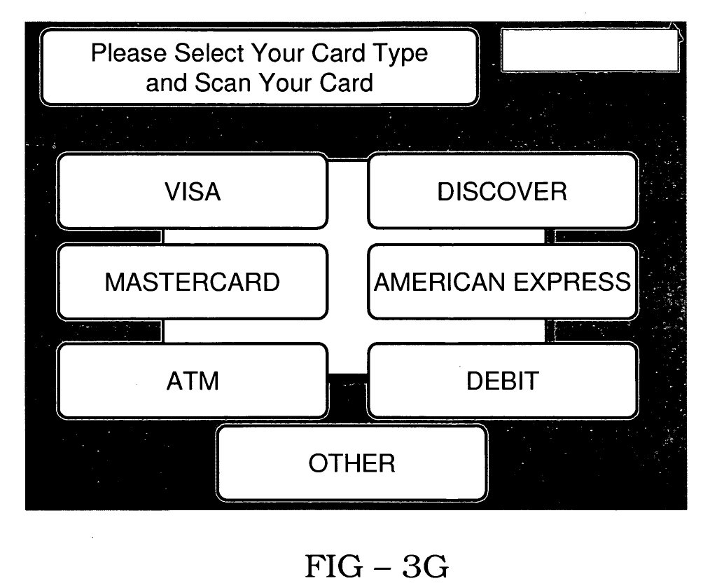

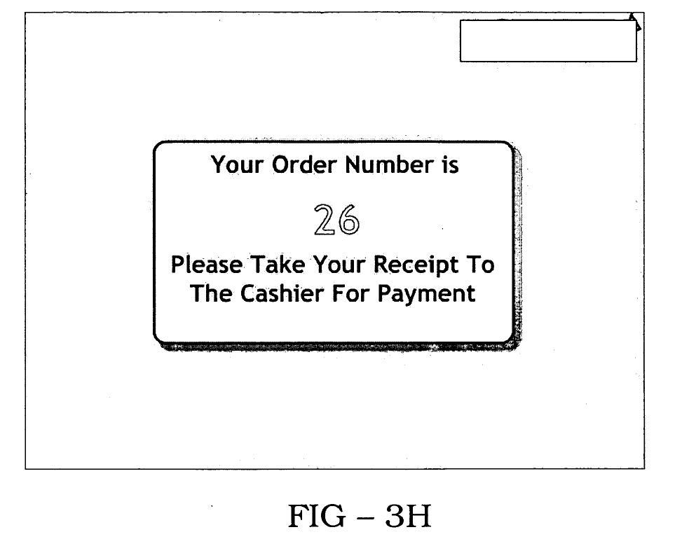

FIG. 3A shows an example of several icons which may be used as a graphical user interface (GUI) to permit a patron to order a sandwich from an in-store sandwich provider (either within the convenience store or as an attached restaurant). Obviously, sandwiches are only one item which could be ordered using the embodiments described herein. However, the specific customer requirements which can be handled by a GUI as shown herein can easily be adapted by one skilled in the art to order any other type of item from a convenience store or associated restaurant.

The menu title 100 may describe the category of icons that are being displayed and may prompt the patron for action/selection. Here, a plurality of different items 105 are being offered. A language icon 106 is also shown which may allow the patron to select a different language. Further, navigation icons 107 may be used to allow the patron to cancel an order, return to a previous menu, or return to the advertisement or other graphics which were previously displayed.

FIG. 3B shows a menu which may follow a patron's selection of ‘sub’ from the previous menu in FIG. 3A. Here, a plurality of different subs 110 are being offered for selection along with a ‘more subs’ icon 111 which may display another menu of available subs. Navigation icons 107 are again shown at the bottom of the GUI.

FIG. 3C shows a menu which may follow a patron's selection of ‘turkey sub’ from the previous menu in FIG. 3B. Here, a plurality of different toppings 115 are being offered for selection along with a more detailed amount icon 116 which permits the patron to select the precise amount of each topping that they desire. An order summary window 117 may be used to provide the patron with a running total cost associated with the current order as well as the details regarding each previous menu selection.

FIG. 3D shows a menu which may follow the previous menu in FIG. 3C. Here, a plurality of different condiments 120 are being offered for selection along with a more detailed amount icon 121 which permits the patron to select the precise amount of each condiment 120 that they desire. The order summary window 117 may be continuously updated as the patron makes each selection.

FIG. 3E shows a menu which may be shown once the patron has had an opportunity to select each of the items that they would like to purchase. Each previously selected item 125 is shown with information about the item as well as a ‘remove’ icon 126 which permits the user to remove the item from the list of selected items 125. The navigation icons 130 may provide a plurality of different functions, including but not limited to: canceling the entire order and returning to a previous message or menu, selecting an additional item for purchase, completing the ordering process and beginning the payment process.

FIG. 3F shows a payment selection screen which may permit the user to select between payment at the fuel pump 131 and payment within the store 132. Again, some embodiments may require the user to pay either at the pump or within the store and thus may lack the payment selection menu shown in FIG. 3F. If the patron selects pay at the pump 131 from the menu in FIG. 3F, a specific payment menu may be shown, possibly similar to that shown in FIG. 3G. Any number of electronic forms of payment or cash may be used to complete the transaction. Once the proper payment icon is selected, the patron may scan any cards or insert any cash for payment. A receipt may then be issued to the patron, who may then enter the store to receive the purchased items.

FIG. 3H shows a menu which may be displayed if the patron selects ‘pay inside’ 132 from the menu shown in FIG. 3F. The order number and/or receipt may be taken into the store for identification of the purchased items and for remitting payment for the items.

Once an order is placed by the patron at the display, exemplary embodiments would contain an in-store notification device which indicates the patron's order details to employees within the convenience store or restaurant. An in-store notification device may be connected to one or more touch screen displays through a wireless or hard-wired connection. An exemplary in-store notification system may contain an additional display within the convenience store or restaurant. This additional display may be a touch screen display. A touch-screen may permit store employees to scan through orders, cancel/delete orders, search, print orders, print receipts, and may provide other functions. It should be noted that a touch screen display is not required for the in-store notification device. Any other type of display may be used. Further, the in-store notification device may instead give hard copy printouts of each order without using any type of display.

Embodiments may utilize different components and may be connected in a variety of different ways to achieve the touch screen display system described herein.

As discussed above, the touch screen display and card reader may function as a POS device. Alternatively, different components may be used to complete the POS device. As used herein, a POS device would typically contain an electronic connection, which may connect with an acquirer (an organization that collects credit-authentication requests from merchants and provides the merchants with a payment guarantee). In some embodiments, the touch screen display and card reader may connect directly with the acquirer. This might be achieved through a wired or wireless internet connection. Alternatively, the touch screen display and card reader may transmit the card information to a central location at the convenience store or restaurant, and the central location may connect directly with the acquirer. Of course, as also discussed above, the touch screen display may not function as a POS device and patrons may be able to order items from the fuel pump area but may have to remit payment at a POS device inside the convenience store or restaurant.

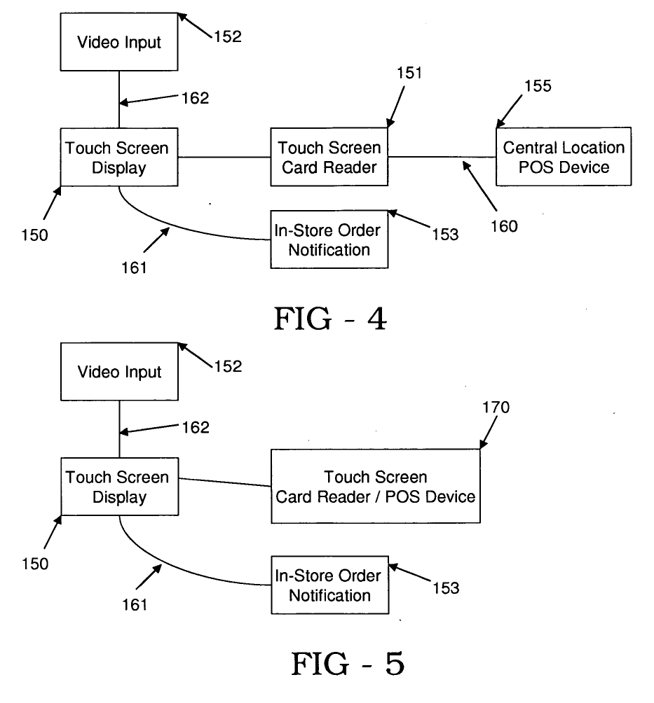

FIG. 4 provides an electrical schematic for one embodiment where the touch screen card reader 151 is in electrical communication 160 with a central POS device 155. In this embodiment, multiple touch screen card readers 151 can utilize a single central POS device 155. The touch screen display 150 is also in electrical communication 161 with an in-store order notification device 153.

A video input device 152 is in electrical communication 162 with the touch screen display 150 and sends video and other necessary display information to the touch screen display. Advertising video/stills, GUI data, updates, sound, and other information may be sent from the video input device 152 to the touch screen display 150. The video input device 152 may be located inside the display housing and hard-wired to the touch screen display 150. In other embodiments, the video input device 152 may be located outside the display housing and may send the video input data to the touch screen display through a wired or wireless connection. Other embodiments may utilize an internet connection (wired or wireless) as the video input device 152 where the necessary data is sent over the internet to the touch screen display 150. This particular setup may be beneficial as convenience store and restaurant operators can easily update the GUI, advertising information, pricing information, and items available for purchase from any location with an internet connection.

FIG. 5 shows another embodiment where the touch screen display 150 works with the touch screen card reader 170 as a POS device. In this embodiment, the touch screen card reader 170 and its associated components would have an electrical connection (not shown) to an acquirer for credit-authentication. This electrical connection may be any common credit/banking institution standard, such as through a phone line or internet connection.

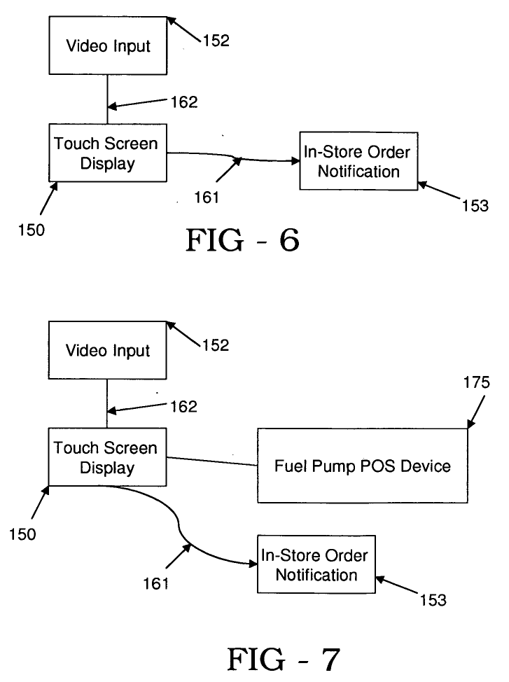

The embodiment in FIG. 6 allows a patron to order items from the fuel pump location, but the items would be paid for within the store. Here, the video input 152 is electrically connected 162 to the touch screen display 150, which is in turn electrically connected 161 to the in-store order notification device 153. This embodiment might be more cost-effective than some of the previous embodiments, as it contains fewer components and would install within existing fuel stations more easily.

The embodiment in FIG. 7 does not provide an additional card reader for the touch screen display but instead uses the existing fuel pump POS device 175. The fuel pump POS device 175 may contain the traditional card reader 13 (shown in FIG. 1) which may already exist on some fuel pumps. The video input device 152, touch screen display 150, and in-store notification device 153 may be connected in a similar manner as to the embodiments described above.

It should be noted that any of the electrical communications 160, 161, and 162, shown in any embodiment, may be wired or wireless. In an exemplary embodiment, the touch screen display would be capable of producing full HD video. An exemplary touch screen display would be an LED-backlight LCD display.

For some embodiments, the card readers disclosed herein may be in the form of the magnetic stripe readers which are capable of accepting any form of electronic payment, including but not limited to: bank cards, credit cards, electronic check cards, ATM cards, and gift cards. For other embodiments, the card readers disclosed herein may be capable of reading from various types of ‘smart cards’ and ‘contactless payment systems.’ Specifically, devices which utilize radio frequency identification (RFID) are specifically contemplated with exemplary embodiments and would be considered with any of the card readers disclosed herein. One such technology would be the ‘blink’ technology currently being offered by Chase bank (www.chaseblink.com) or the Speedpass™ technology currently offered from Exxon Mobile (www.speedpass.com). Further embodiments may also contain a cash receiving/dispending assembly (not shown) which can accept payment for the in-store items (and/or fuel) in the form of cash and may remit change also in the form of cash.

It should also be noted that the ‘fuel pumps’ described herein are in no way limited to gasoline/diesel pumps. Any form of energy used to power automobiles may be used with any embodiment, including but not limited to: bio-fuels, hydrogen, natural gas, and electrical energy.

Having shown and described preferred embodiments, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

1. A system for ordering in-store items from a fuel pump comprising:
a touch screen display in proximity to a fuel pump and adapted to present several in-store items for selection by the user; and
a second display in electrical communication with the touch screen display and adapted to communicate the user's selected items to an in-store employee.

2. The system of claim 1 further comprising:
a point-of-sale device in electrical communication with the touch screen display.

3. The system of claim 1 further comprising:
a proximity sensor in electrical communication with the touch screen display.

4. The system of claim 1 further comprising:
a card reading device in electrical communication with the touch screen display.

5. The system of claim 1 further comprising:
an audio device in electrical communication with the touch screen display.

6. The system of claim 1 further comprising:
a receipt printing device in electrical communication with the touch screen display.

7. A system for ordering in-store items from the proximity of a fuel pump comprising:
a touch screen display in proximity to a fuel pump and adapted to present several in-store items for selection by the user;
a video input device in electrical communication with the touch screen display and adapted to send video and GUI data to the touch screen display;
a card reading device in electrical communication with the touch screen display;
a point-of-sale device in electrical communication with the card reading device; and
a second display in electrical communication with the touch screen display and adapted to communicate the user's selected items to an in-store employee.

8. The system of claim 7 further comprising:
a proximity sensor in electrical communication with the touch screen display.

9. The system of claim 7 further comprising:
an audio device in electrical communication with the touch screen display.

10. The system of claim 7 further comprising:
a receipt printing device in electrical communication with the touch screen display.

11. A fuel pump having a touch screen display for ordering in-store items comprising:
a fuel pump;
a high definition touch screen display mounted adjacent to the fuel pump and adapted to present a GUI containing in-store items to a user; and
a second display in electrical communication with the touch screen display and adapted to communicate the user's selected items to an in-store employee.

12. The fuel pump from claim 11 further comprising:
a card reading device in electrical communication with the touch screen display.

13. The fuel pump from claim 12 further comprising:
a point-of-sale device in electrical communication with the card reading device.

14. The fuel pump from claim 11 further comprising:
a proximity sensor in electrical communication with the touch screen display.

15. The fuel pump from claim 11 further comprising:
an audio device in electrical communication with the touch screen display.

16. The fuel pump from claim 11 further comprising:
a receipt printing device in electrical communication with the touch screen display.

17. The fuel pump from claim 15 wherein:
said audio device is a hypersonic sound device.

18. The fuel pump from claim 11 further comprising:
a video input device having a wireless electrical connection with said touch screen display.

19. The fuel pump from claim 12 wherein:
said card reader is a radio frequency identification device.

20. The fuel pump from claim 11 wherein:
said high definition touch screen display is an LED-backlit LCD display.
